(19) United States
(12) Patent Application Publication
(10) Pub. No.: US 2003/0122872 A1
(43) Pub. Date: Jul. 3, 2003

(54) Graphics computer programming language for the creation of interactive virtual world

(76) Inventors: Kuo-Chang Chiang, R. Heights, CA (US); Tuan Phan, Cambridge, MA (US); John Leffingwell, Pasadena, CA (US)

Correspondence Address: Mr. C.P. Chang, Pacific Law Group LLP, Suite 290, Two North Second Street, San Jose, CA, 95113, US

(21) Appl. No.: 10/039,354

(22) Filed: Dec. 31, 2001

(51) Int. Cl. G09G 5/00

(52) U.S. Cl. 345/763

(57) ABSTRACT

A graphics computer programming language, called the BDT Language, is disclosed for the description of three-dimensional objects and real-time interactions among them in a three-dimensional space. The BDT Language consists of a User Level Command Script and a corresponding Language Level Program Code. The User Level Command Script consists of command lines each having a mnemonical name followed by a list of arguments. The Language Level Program Code consists of a corresponding number of program lines each having an operation code for the command followed by a list of arguments. The Language Level Program Code is further compressed into a BDT File for efficient storage and download for viewing by a client user with a Web Browser. A BDT Interpreter is also devised to parse the BDT File into instructions for a separate display Engine for final rendition into the originally created set of three-dimensional objects.

### CROSS REFERENCE TO RELATED APPLICATION

This application is related to a prior application, Ser. No., 09/893,834, filed on Jun. 27, 2001 by the same inventors, now abandoned.

### REFERENCE TO A CDROM APPENDIX

A CDROM with a label of “Complete Syntax Itemization of the BDT Language” is submitted as part of the specification of this patent application. The content of this CDROM, being made up of a simple text file, is a complete itemization of the syntax of a graphics programming language that is the subject matter of the current invention.

### FIELD OF THE INVENTION

This invention is related to a graphics programming language and its associated interpreter. More specifically, the present invention concerns the efficient description, by a computer language, and the interpretation of a set of three dimensional, or 3D, objects and interactions among them in a 3D space. During application, the subject computer language file is downloadable for viewing by a client user with a Web Browser within the popular Internet or a more general networked computer environment. Some examples of Web Browser are Internet Explorer and Netscape communicator.

### BACKGROUND OF THE INVENTION

The past five years have seen explosive growth of the Internet infrastructure and its associated applications for both the business world and the end user community. The trend going forward is expected to be one of even faster growth with likely more emphasis on the application development as the Internet infrastructure starts to mature. In the area of fundamental computer programming language for application development for the Internet, a highly portable, platform independent and secure language such as JAVA has already become pervasive. Likewise, a Web Browser, such as Internet Explorer or Netscape communicator, has also evolved to become a ubiquitous application for the man-computer interface in an Internet environment. Meanwhile, although the demand for high efficiency, high quality, interactive 3D graphics and related computer gaming through the Internet also continues to rise, existing 3D graphics programming languages tend to be rather inadequate in satisfying this demand. An example is the VRML (or Virtual Reality Modeling Language) computer language. Although devised for the description of three-dimensional scenes, the VRML file does not contain information about the interactions among 3D objects and their surrounding 3D environments. Specifically, within an application, the VRML browser can only interpret the user's mouse movement and keyboard strokes as moving orders: such as going forward, turning left, looking up, etc., instead of interacting orders, such as triggers and actions. Secondly, the transportation and storage of the resulting application is still inefficient and slow, in the Internet environment as the generated VRML file is in text format therefore its size tends to be rather large. Thirdly, a VRML file cannot be directly run within a standard Web browser. To view three-dimensional scenes generated by a VRML file, a plug-in VRML browser, such as Live3D (for a Netscape Browser) or VRML Add-In (for a Microsoft Browser), would be required and this is rather cumbersome.

As stated, despite the existence of 3D graphics programming language in the prior art, there are still some disadvantages in them especially when they are employed in a networked W computer environment such as the Internet.

### SUMMARY OF THE INVENTION

The present invention is directed to the aspects of language definition and associated interpreter of a graphics programming language to be used in the development of three-dimensional interactive graphics applications in a networked computer environment such as the Internet. Although, the same invention will function just as well in a classic desktop environment.

The first objective of this invention is to define a graphics programming language, called the “BDT Language”, for a highly efficient and compressed representation, called the “BDT File”, of a set of three dimensional objects and interactions among them in a three dimensional space. Thus, the BDT Language can be efficiently transported and stored in a networked computer environment such as the Internet.

The second objective of this invention is to create an interpreter, called the “BDT Interpreter”, for the aforementioned BDT Language representation, to decompress and parse the BDT File for further rendering and viewing of the 3D objects within the three dimensional space as originally created before.

The third objective of this invention is to have the aforementioned BDT File to be easily downloadable by an existing Web Browser, such as Internet Explorer or Netscape Communicator, for further processing by the BDT Interpreter as stated above.

### BRIEF DESCRIPTION OF DRAWINGS

FIG. 1 is an overview of the Application Process Flow for the BDT graphics programming language;

FIG. 2 shows a breakdown of the major sections of the BDT graphics programming language;

FIGS. 3a and 3b are partial itemization of the first three sections of the BDT graphics programming language;

FIG. 4 is a partial itemization of the last three sections of the BDT graphics programming language;

FIG. 5 shows an example of a simple 3D graphics program using the BDT graphics programming language; and

FIG. 6 illustrates the functionality of the BDT Interpreter for the BDT graphics programming language.

### DETAILED DESCRIPTION OF PREFERRED EMBODIMENTS

The definition of 3D graphics is to render three-dimensional objects on a two-dimensional image plane. In order to render an interactive set of three-dimensional objects within a three-dimensional scene, a computer graphics system must provide two main sets of functionality. The first set of functionality encompasses the representation of a set of 3D objects and interactions among them in a three-dimensional space. Thus, a precise internal representation of the 3D objects as they exist in a three-dimensional space, such as the shape, orientation, color, texture and position of the object must exist. In addition, the interaction among the objects and the lighting of the subject scene must also be described, as well as the point from which the subject scene is being viewed. For this purpose, a set of command names and their respective syntax of operational codes and arguments needs to be precisely defined and it is called a graphics programming language in the art. Next, in order for the computer to understand this graphics programming language, a software program, called a language interpreter in the art, needs to be written which works with the precise definition of the subject graphics programming language. Afterwards, a second set of functionality must be implemented which converts the subject three-dimensional scene into a proper two-dimensional image for final viewing by the client-user. Like the language interpreter, this second set of functionality is also provided by another software program which is usually called a 3D Engine in the art. As the Web Browser, such as Internet Explorer or Netscape Communicator, has already become a ubiquitous application for the man-computer interface in an Internet environment, both the first set and the second set of functionality need to be downloadable by the Web Browser. Specifically, this means that the user-composed graphics programming language file, the language interpreter and the 3D Engine all need to be easily downloadable by the Web Browser. As stated before, the JAVA programming language has already become pervasive for application development for the Internet. Additionally, a JAVA program can be directly executed over the Internet without having the client-user to first download and install it. Therefore, for convenience of the client-user, both the language interpreter and the 3D Engine should be written in JAVA.

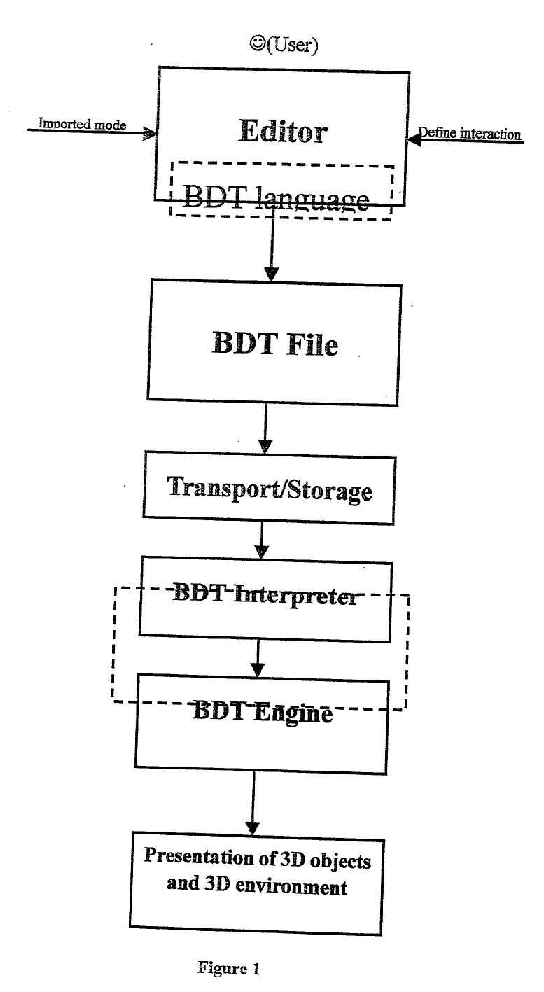

For a clear understanding of the application environment of the current invention, reference is made to FIG. 1, which is an overview of the Application Process Flow for the BDT Language. Starting from the top, an Editor is a program that allows an interactive composition of a BDT language file by an original creator of 3D graphics that was already defined to be a set of three-dimensional objects within a three-dimensional scene or succession of scenes. There are two modes of operation of the editor. Through the first mode, labeled “Define interaction”, the original creator will compose the subject 3D graphics himself. Alternatively through the second mode, labeled “Imported mode”, the original creator will compose the subject 3D graphics by importing an existing BDT language file previously created by someone else. As highlighted within the “Editor” block with a dashed rectangle to be one of the foci of the current invention, the “BDT Language” definition is the core focus of the “Editor” which, based upon the creator's input, has to generate a BDT language file totally consistent with the BDT Language definition. For the most efficient transport and storage of the resulting data in a networked computer environment such as the Internet, the BDT language file is further compressed into a highly compact binary file. It should be noted that a variety of algorithms are available to perform the function of data compression and subsequent data decompression. The resulting BDT language file is shown as the block labeled “BDT File”. It is important to notice that, typically, the BDT File size is only about 15-35% of that of the corresponding VRML Text format, a prior art 3D graphics programming language. Next, the activity of transport and storage of the BDT File in a networked computer environment is represented by the block labeled “Transport/Storage”. A client-user of the BDT File then uses a “BDT Interpreter”, so illustrated with another block in FIG. 1, to interpret the BDT File into meaningful information within the context of the BDT Language. Like the Editor, the BDT Interpreter itself is also a program. It is important to remark that, as the BDT File is a compressed binary file, data decompression needs to be done first by the BDT Interpreter before it can perform the function of interpretation. Notice that the “BDT Interpreter” block is also highlighted with a dashed rectangle to be another one of the foci of the current invention. As mentioned before, the output of the BDT Interpreter is still a three-dimensional scene that needs to be converted into a proper two-dimensional image for final viewing by the client-user. This function of conversion is performed by the block labeled “BDT Engine” as seen. Therefore, like the Editor and the BDT Interpreter, the BDT Engine itself is also a program. The final viewing by the client-user of the subject 3D graphics is signified by the block labeled “Presentation of 3D objects and 3D environment”.

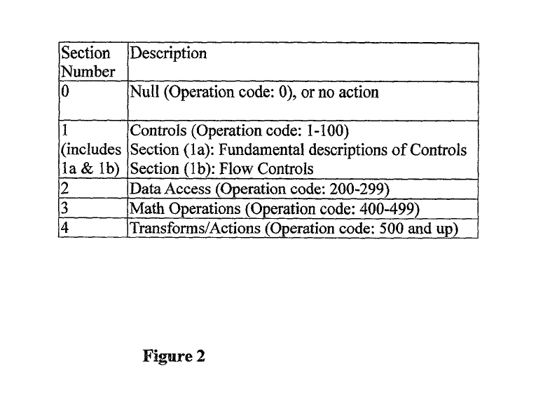

To elucidate the structure of the definition of the BDT Language, reference is made to FIG. 2 which shows a tabulated breakdown of the major Sections of the BDT Language by functional category. To ease the implementation of the BDT Interpreter later, a range of Operation codes is assigned to each Section in an ascending order. Section zero (0) is the Null Section, or no action. The corresponding Operation code is zero (0). The Null command is used as a useful delimiter in the listing of the BDT Language to improve its readability. Section one (1), including sub-Sections 1a and 1b, is the Controls Section. The range of Operation codes assigned to the Controls Section is from 1 to 100. The various members of the BDT Language under the Controls Section are devised to handle administrative tasks that control the appearance and disappearance of various graphic activities and the associated overall flow of them. Thus, the Sub-Section 1a, with Operation codes 1-50, comprises BDT Language members that cause the appearance and disappearance of various graphic activities within any scenario of application. On the other hand, the Sub-Section 1b, with Operation codes 51-99, comprises BDT Language members that control the overall flow of these graphic activities within any application.

Section two (2), having an Operation code range of 200-299, of the BDT Language is the Data Access Section. The BDT Language members of this Section are used to get properties and parameters of a variety of objects created within any application of the BDT Language.

Section three (3), having an Operation code range of 400-499, of the BDT Language is the Math Operations Section. The BDT Language members of this Section are used to perform a variety of mathematical operations amongst a set of designated variables and constants created within any application of the BDT Language.

Finally Section four (4), having an Operation code range of 500 and up, of the BDT Language is the Transforms/Actions Section. The BDT Language members of this Section are used to cause a variety of Transforms or Actions by a designated object created within any application of the BDT Language.

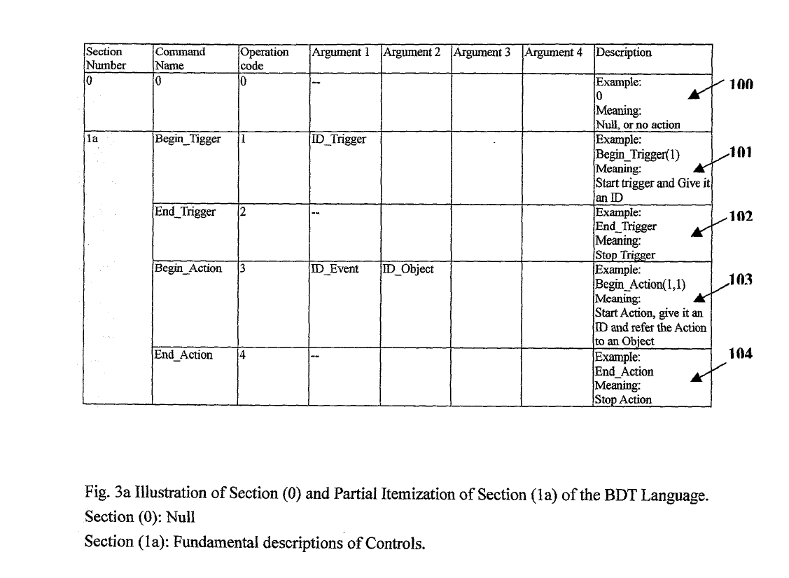

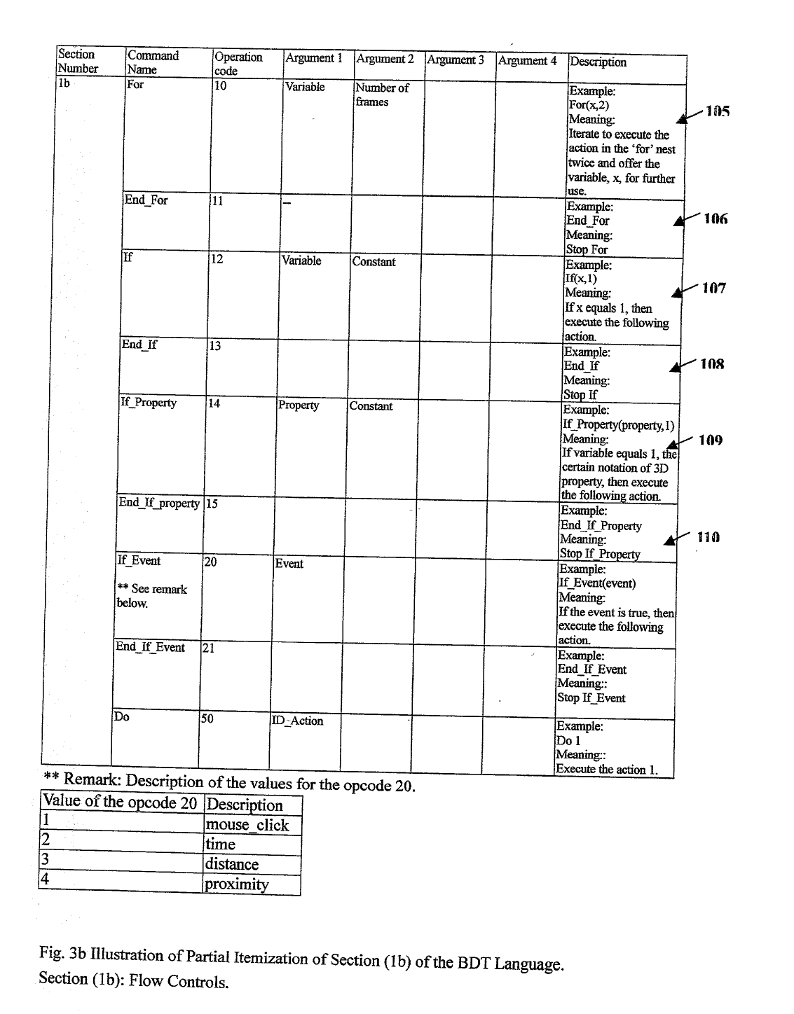

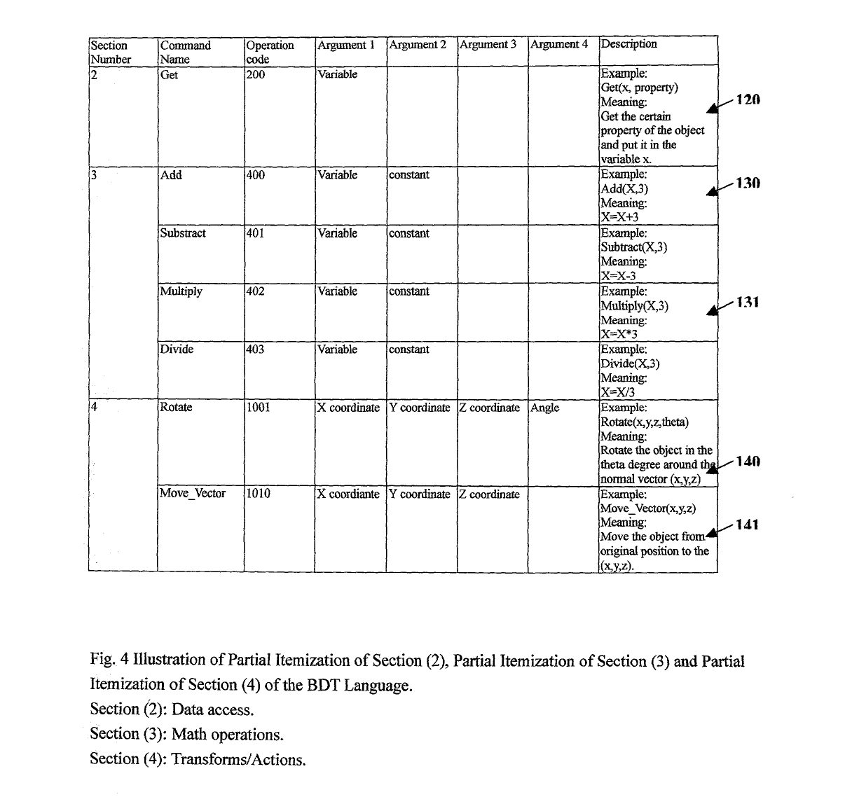

To further clarify the detailed syntax and its associated operation codes of the BDT Language, a set of selected specific examples each having a single command line are explained from a set of tables from FIG. 3a to FIG. 4. Notice that, only partial itemization of many Sections of the BDT Language are presented herein to control the amount of detailed itemization within a reasonable limit without loosing the spirit and scope of this invention. The structure of these tables are now described as below.

The entry for the first column is the Section Number. For example, the Section Number of the Null Section is zero (0). The entry for the second column is the Command Name. For example, the name “Begin_Trigger” is the entry at the second row of the second column. The entry for the third column is the Operation code. For example, the Operation code “1” is the entry at the second row of the third column, which is the Operation code for the Command Name “Begin_Trigger”. The entry for the fourth through the seventh column are the arguments for the Command Name, they are Argument 1, Argument 2, Argument 3 and Argument 4. For example, the argument “ID_Trigger” is the entry at the second row of the fourth column, which is Argument 1 for the Command Name “Begin_Trigger”. A so-called “User Level Command Script” is defined as follows:

Command Name(Argument 1,Argument 2,Argument 3,Argument 4)

and a corresponding “Language Level Program Code” is defined to be:

(Operation code, Argument 1, Argument 2, Argument 3, Argument 4).

Finally, the entry for the eighth column is the detailed description for the above User Level Command Script, or equivalently, the output of the BDT Interpreter after it sees the corresponding Language Level Program Code for the subject Command Name from a BDT File. For example, the description “Example: End_Action Meaning: Stop Action” is the entry at the sixth row of the eighth column, which is the description for the Command Name “End_Action”, etc.

In this way, FIG. 3a consists of an illustration of Section (0) and a partial itemization of Section (1a) of the BDT Language. As the Null Section, Section zero (0), consists of only a single member, this member is labeled as BDT Language Section 0 first example 100 and has the following trivial Command Name, Operation code, User Level Command Script, Language Level Program Code and description:

Command Name=0;

Operation code=0;

User Level Command Script=0;

Language Level Program Code=(0,0,0,0,0); and

description of Null, or no action.

Likewise, for the Controls Section 1a, a BDT Language Section 1a first example 101 has the following specifics:

Command Name=Begin_Trigger;

Operation code=1;

Argument 1=ID Trigger;

User Level Command Script=Begin_Trigger (ID_Trigger);

Language Level Program Code=(1, ID_Trigger,0,0,0); and

description of “Start trigger and Give it an ID”, meaning starting a trigger action and giving the trigger action an identification.

A BDT Language Section 1a second example 102, of the Controls Section 1a, has the following specifics:

Command Name=End_Trigger;

Operation code=2;

User Level Command Script=End_Trigger;

Language Level Program Code=(2,0,0,0,0); and

description of “Stop Trigger”, meaning stopping a trigger action.

A BDT Language Section 1a third example 103, of the Controls Section 1a, has the following specifics:

Command Name=Begin_Action;

Operation code=3;

Argument 1=ID-Event;

Argument 2=ID-Object;

User Level Command Script=Begin_Action;

Language Level Program Code=(3, ID-Event, ID-Object,0,0); and

description of “Start Action, give it an ID and refer the Action to an Object”, meaning starting an action, give it an ID of “ID-Event” and refer the Action to an Object with the ID of “ID-Object”.

A BDT Language Section 1a fourth example 104, of the Controls Section 1a, has the following specifics:

Command Name=End_Action;

Operation code=4;

User Level Command Script=End_Action;

Language Level Program Code=(4,0,0,0,0); and

description of “Stop Action”, meaning simply stopping the Action.

Now referring to FIG. 3b, there is an illustration of Partial Itemization of Section (1b) of the BDT Language. A BDT Language Section 1b first example 105, of the Controls Section 1b, has the following specifics:

Command Name=For;

Operation code=10;

Argument 1=Variable=x;

Argument 2=Number of frames=2;

User Level Command Script=For(Variable, Number of frames)=For(x,2);

Language Level Program Code=(10,Variable, Number of frames,0,0)=(10,x,2,0,0); and the meaning of “Iterate to execute the action in the ‘for’ nest twice and offer the variable, x, for further use”.

A BDT Language Section 1b second example 106, of the Controls Section 1b, has the following specifics:

Command Name=End_For;

Operation code=11;

User Level Command Script=End_For;

Language Level Program Code=(11,0,0,0,0); and

the meaning of “Stopping the ‘for’ nest loop”.

A BDT Language Section 1b third example 107, of the Controls Section 1b, has the following specifics:

Command Name=If;

Operation code=12;

Argument 1=Variable=x;

Argument 2=Constant=1;

User Level Command Script=If(Variable, Constant)=If(x,1);

Language Level Program Code=(12, Variable, Constant,0,0)=(12,x,1,0,0); and

the meaning of “If x equals 1, then execute the following action”.

A BDT Language Section 1b fourth example 108, of the Controls Section 1b, has the following specifics:

Command Name=End_If;

Operation code=13;

User Level Command Script=If;

Language Level Program Code=(13, 0,0,0,0); and

the meaning of “Stopping the If related statements here”.

A BDT Language Section 1b fifth example 109, of the Controls Section 1b, has the following specifics:

Command Name=If Property;

Operation code=14;

Argument 1=Property;

Argument 2=Constant=1;

User Level Command Script=If_Property(Property,Constant)=If_Property(Property,1);

Language Level Program Code=(14,Property,Constant,0,0)=(14, Property,1,0,0); and

the meaning of “If Property equals 1, which denotes certain 3D property, then execute the following action.”.

A BDT Language Section 1b sixth example 110, of the Controls Section 1b, has the following specifics:

Command Name=End_If_Property;

Operation code=15;

User Level Command Script=End_If_Property;

Language Level Program Code=(15,0,0,0,0); and

the meaning of “Stopping the If Property related statements here”.

Next referring to FIG. 4, there is an illustration of Partial Itemization of Section (2), Partial Itemization of Section (3) and Partial Itemization of Section (4) of the BDT Language. A BDT Language Section 2 first example 120, of the Data Access Section, has the following specifics:

Command Name=Get;

Operation code=200;

Argument 1=Variable=x;

User Level Command Script=Get(Variable)=Get(x);

Language Level Program Code=(200,Variable,0,0,0)=(200,x,0,0,0); and

the meaning of “Get the property of the object and put it in the variable x”.

A BDT Language Section 3 first example 130, of the Math Operations Section, has the following specifics:

Command Name=Add;

Operation code=400;

Argument 1=Variable=X;

Argument 2=Constant=3;

User Level Command Script=Add(Variable,Constant)=Add(X,3);

Language Level Program Code=(400, Variable,Constant,0,0)=(400, X,3,0,0); and

the meaning of “setting X=X+3”.

A BDT Language Section 3 second example 131, of the Math Operations Section, has the following specifics:

Command Name=Multiply;

Operation code=402;

Argument 1=Variable=X;

Argument 2=Constant=3;

User Level Command Script=Multiply(Variable,Constant)=Multiply(X,3);

Language Level Program Code=(402, Variable,Constant,0,0)=(402, X,3,0,0); and

the meaning of “setting X=X*3”.

A BDT Language Section 4 first example 140, of the Transforms/Actions Section, has the following specifics:

Command Name=Rotate;

Operation code=1001;

Argument 1=X coordinate=x;

Argument 2=Y coordinate=y;

Argument 3=Z coordinate=z;

Argument 4=Angle=theta;

User Level Command Script=Rotate(X coordinate,Y coordinate,Z coordinate,Angle)=Rotate(x,y,z,theta);

Language Level Program Code=(1001,X coordinate,Y coordinate,Z coordinate,Angle)=(1001,x,y,z,theta); and

the meaning of “Rotating the object by theta degree around the normal vector (x,y,z)”.

A BDT Language Section 4 second example 141, of the Transforms/Actions Section, has the following specifics:

Command Name=Move_Vector;

Operation code=1010;

Argument 1=X coordinate=x;

Argument 2=Y coordinate=y;

Argument 3=Z coordinate=z;

User Level Command Script=Move_Vector(X coordinate,Y coordinate,Z coordinate)=Move_Vector(x,y,z);

Language Level Program Code=(1010,X coordinate,Y coordinate,Z coordinate)=(1010,x,y,z); and

the meaning of “Moving the object from its original position to the new position with Cartesian coordinates (x,y,z)”.

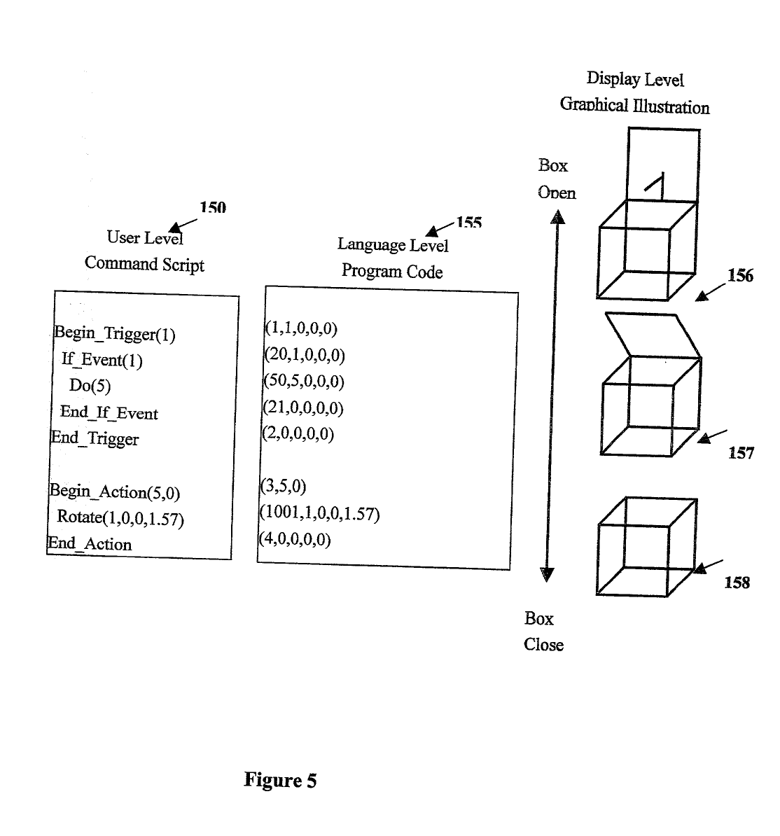

Having the detailed syntax and its associated operation codes of the individual commands of the BDT Language explained in the numerous examples above, an application example consisting of multiple, sequentially arranged command lines of the BDT Language is now illustrated in FIG. 5. The User Level Command Script composition of this example, located in the left-hand part of FIG. 5, is labeled 150. The associated Language Level Program Code composition, located in the center part of FIG. 5, is labeled 155. The corresponding graphical activities, generated by the Language Level Program Code composition 155 as indicated in the right hand side of FIG. 5, is illustrated by a sequence of Graphical illustration events such as Graphical illustration event one of an example BDT Language Command Script 156, Graphical illustration event two of an example BDT Language Command Script 157 and Graphical illustration event three of an example BDT Language Command Script 158. Notice that, moving downwards from the top, there is a line-to-line correspondence between the User Level Command Script composition 150 and its associated Language Level Program Code composition 155. This can be seen in the following example:

“Begin_Action(5,0)” corresponds to: “(3,5,0)”

“Rotate(1,0,0,1.57)” corresponds to: “(1001,1,0,0,1.57)”

“End_Action” corresponds to: “(4,0,0,0,0)”.

Notice that, the number “1.57” from the User Level Command Script line “Rotate(1,0,0,1.57)” means 1.57 radian, which is the same as 90 Degree. Thus, parsing the Language Level Program Code composition 155 associated with the User Level Command Script composition 150 line by line in the same manner as explained before, the BDT Interpreter reaches the conclusion that the corresponding graphical activities are the illustrated action of closing a box with a 90 Degree rotation of its lid.

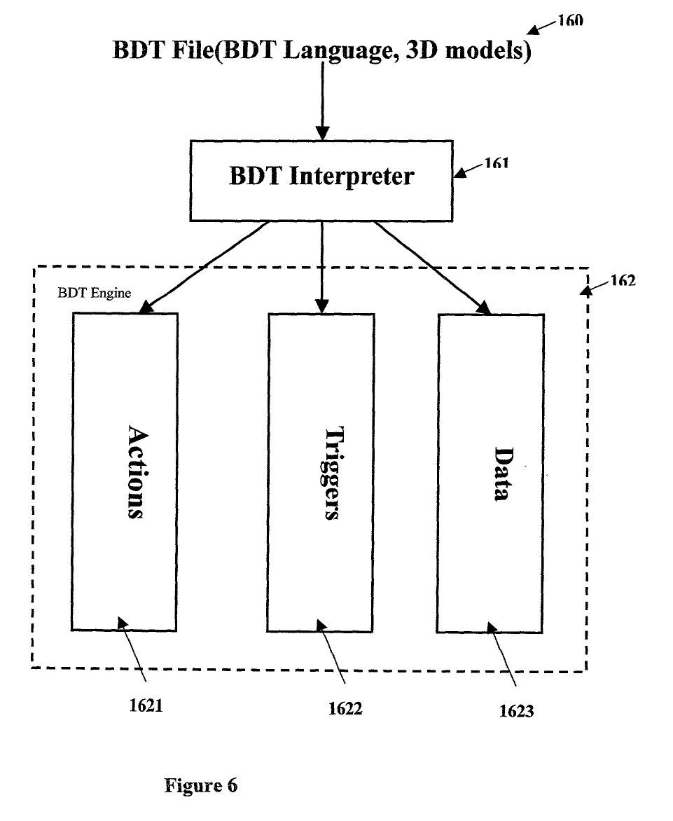

FIG. 6 is an illustration, in the form of a flow chart, of the functionality of the BDT Interpreter for the BDT graphics programming language. The input of the BDT Language Interpreter 161 is a BDT Language File 160. The BDT Language File 160 consists of BDT Language and 3D models. The BDT Language and 3D models are a program composition and an underlying set of defined three-dimensional graphical objects invoked by the composition for its execution. Parsing this input in a manner as—explained above, the BDT Language Interpreter 161 would produce a set of instructions, illustrated by a set of three lines with arrow heads, for the BDT Engine 162. As seen, the instructions for the BDT Engine 162 are further classified into BDT Engine Actions 1621, BDT Engine Triggers 1622 and BDT Engine Data 1623 for the final rendering into displayed graphics by the BDT Engine 162.

As described, a graphics programming language and its associated interpreter have been illustrated for the efficient description and interpretation of a set of three dimensional objects and interactions among them in a three dimensional space. During application, the related graphics language file is downloadable for viewing by a client user with a Web Browser within a networked computer environment. The invention has been described using exemplary preferred embodiments. However, for those skilled in this field, the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A graphics computer programming language for the efficient description and rendition of a set of three-dimensional objects and real-time interactions among the three-dimensional objects in a three dimensional space for performing an application within a computing device or a general networked computer environment, comprising:
a user level command script consisting of a number of consecutive individual command lines wherein each of the command lines further comprises a mnemonical name of a specific command corresponding to the command line followed by an ordered list of arguments for the specific command;
a language level program code having a one-to-one correspondence with the user level command script wherein the language level program code comprises the same number of consecutive individual program lines with each of the program lines further consisting of an operation code for the mnemonical name of the specific command followed by a correspondingly ordered list of arguments for the specific command;
a language interpreter whereby the number of consecutive individual program lines of the language level program code get parsed into a corresponding set of instructions for display; and
a display engine whereby the set of instructions for display produced by the language interpreter get rendered into the set of three-dimensional objects and the real-time interactions among them in a three dimensional space for graphics presentation or storage in the computing device or the general networked computer environment.

2. The graphics computer programming language as described in claim 1 wherein the set of operation codes of the language level program code is functionally partitioned into a number of sections to improve the performance of the function of parsing for the language interpreter.

3. The graphics computer programming language as described in claim 2 wherein each of the number of sections further comprises a specific definition and a range of operation codes consecutively assigned thereof.

4. The graphics computer programming language as described in claim 3 wherein one of the number of sections is section zero (0) being defined as a null section, corresponding to no action, having a singular numerical operation code of zero (0).

5. The graphics computer programming language as described in claim 3 wherein one of the number of sections is section one (1) being defined as a controls section, comprising a set of control functions, having a range of numerical operation codes from 1 to 100.

6. The graphics computer programming language as described in claim 3 wherein one of the number of sections is section two (2) being defined as a data access section, comprising a set of functions for data access, having a range of numerical operation codes from 200 to 299.

7. The graphics computer programming language as described in claim 3 wherein one of the number of sections is section three (3) being defined as a math operations section, comprising a set of functions for mathematical operations, having a range of numerical operation codes from 400 to 499.

8. The graphics computer programming language as described in claim 3 wherein one of the number of sections is section four (4) being defined as a transforms/actions section, comprising a set of functions causing transformations or actions of a number of selected members of the set of three-dimensional objects, having a range of numerical operation codes from 500 and up.

9. The graphics computer programming language as described in claim 1 wherein the computing device is a game console or a desk top computer.

10. The graphics computer programming language as described in claim 1 wherein the general networked computer environment includes, but not limited to, the Internet.

11. The graphics computer programming language as described in claim 10 wherein the graphics computer programming language is downloadable for viewing by a client user with a web browser includes, but not limited to, Internet Explorer or Netscape communicator.

12. A graphics computer programming language for real-time presentation, storage or transport of a set of three-dimensional objects having a compact size in a three dimensional space within a computing device or a general networked computer environment, comprising:
a user level command script consisting of a number of consecutive individual command lines wherein each of the command lines further comprises a mnemonical name of a specific command corresponding to the command line followed by an ordered list of arguments for the specific command;
a language level program code having a one-to-one correspondence with the user level command script wherein the language level program code comprises the same number of consecutive individual program lines with each of the program lines further consisting of an operation code for the mnemonical name of the specific command followed by a correspondingly ordered list of arguments for the specific command whereby the operation code and the correspondingly ordered list of arguments are symbolically defined to be pure numerical numbers, pure alphabets or alphanumerics to make the corresponding presentation, storage or transport of the objects compact in size.
a language interpreter whereby the number of consecutive individual program lines of the language level program code get parsed into a corresponding set of instructions for display; and
a display engine whereby the set of instructions for display produced by the language interpreter get rendered into the set of three-dimensional objects and the real-time interactions among them in a three dimensional space for graphics representation or storage in the computing device or the general networked computer environment.

13. The graphics computer programming language for real-time presentation, storage or transport of a set of three-dimensional objects in claim 12 wherein the language level program code is further compressed into a final file with a variety of industry standard algorithms and coding schemes including, but not limited to, ZIP Code or Hoffman Code.

14. The graphics computer programming language for real-time presentation, storage or transport of a set of three-dimensional objects in claim 12 wherein the language interpreter is further provided with a functional component of file decompression such that the compressed final file is first decompressed into the corresponding language level program code before it gets parsed into the corresponding set of instructions by the language interpreter for display.

15. The graphics computer programming language as described in claim 12 wherein the set of operation codes of the language level program code is functionally partitioned into a number of sections to improve the performance of the function of parsing for the language interpreter.

16. The graphics computer programming language as described in claim 15 wherein each of the number of sections further comprises a specific definition and a range of operation codes consecutively assigned thereof.

17. The graphics computer programming language as described in claim 16 wherein one of the number of sections is section zero (0) being defined as a null section, corresponding to no action, having a singular numerical operation code of zero (0).

18. The graphics computer programming language as described in claim 16 wherein one of the number of sections is section one (1) being defined as a controls section, comprising a set of control functions, having a range of numerical operation codes from 1 to 100.

19. The graphics computer programming language as described in claim 16 wherein one of the number of sections is section two (2) being defined as a data access section, comprising a set of functions for data access, having a range of numerical operation codes from 200 to 299.

20. The graphics computer programming language as described in claim 16 wherein one of the number of sections is section three (3) being defined as a math operations section, comprising a set of functions for mathematical operations, having a range of numerical operation codes from 400 to 499.

21. The graphics computer programming language as described in claim 16 wherein one of the number of sections is section four (4) being defined as a transforms/actions section, comprising a set of functions causing transformations or actions of a number of selected members of the set of three-dimensional objects, having a range of numerical operation codes from 500 and up.

22. The graphics computer programming language as described in claim 12 wherein the computing device is a game console or a desk top computer.

23. The graphics computer programming language as described in claim 12 wherein the general networked computer environment includes, but not limited to, the Internet.

24. The graphics computer programming language as described in claim 23 wherein the graphics computer programming language is downloadable for viewing by a client user with a web browser includes, but not limited to, Internet Explorer or Netscape communicator.
